(19) United States
(12) Patent Application Publication
(10) Pub. No.: US 2010/0210757 A1
(43) Pub. Date: Aug. 19, 2010

(54) Aqueous Coating Systems Based On Physically Drying Urethane Acrylates

(75) Inventors: Stefan Sommer, Leverkusen (DE); Harald Blum, Hafenlohr (DE); Jürgen Lippemeier, Koln (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/704,804

(22) Filed: Feb. 12, 2010

(30) Foreign Application Priority Data
Feb. 13, 2009 (DE) 102009008949.7

(51) Int. Cl. C09D 175/04; C08L 75/04

(52) U.S. Cl. 523/402; 524/591; 524/507

(57) ABSTRACT

The invention relates to radiation-curable coating systems based on aqueous polyurethane dispersions, to a process for their production, to the use of the coating systems as lacquers and/or adhesives, and also to articles and substrates provided with these lacquers and/or adhesive.

### RELATED APPLICATIONS

This application claims benefit to German Patent Application No. 10 2009 008 949.7, filed Feb. 13, 2009, which is incorporated herein by reference in its entirety for all useful purposes.

### BACKGROUND OF THE INVENTION

The present invention describes radiation-curable coating systems based on aqueous polyurethane dispersions, a process for their production, the use of the coating systems as lacquers and/or adhesives, and also articles and substrates provided with these lacquers and/or adhesives.

Radiation-curable, aqueous coating systems based on polyurethane polymers are used in the coating of, inter alia, wood, plastics and leather and are distinguished by a large number of positive properties, such as good resistance to chemicals and mechanical stability. A particular advantage is that the polyurethane top layer cures in seconds by crosslinking of the ethylenic double bonds contained in the polymer by means of high-energy radiation.

For many applications, for example in the coating of wood/furniture or of plastics, considerable initial physical drying after the water has been allowed to evaporate and before the radiation curing plays an extraordinarily important role. Coatings which, after the water has been allowed to evaporate, are dry to touch and resistant to blocking and have not yet been radiation cured can accordingly already be sanded, stacked and subjected to many different mechanical loads.

For pigmented lacquers there is a further, important advantage if the coatings are dry to touch and resistant to blocking even in the non-radiation-cured state. Pigments, for example titanium dioxide, scatter and absorb UV radiation and, in the case of a high pigment content, can have the effect that the radiation-induced polymerisation takes place incompletely in deeper lacquer layers. In systems that are still tacky before the radiation curing, this means that there is a soft, or still viscous, layer beneath the cured upper layer after the radiation curing. The result is poor adhesion to the substrate and poor resistance to chemicals and colouring agents. If the bottom layer of a pigmented lacquer is hard and tack-free per se, despite unsatisfactory radiation curing, both the adhesion and the resistance are improved.

The demands made of modern coating systems are many and varied. For example, it is not only advantageous for radiation-curable coating systems to be resistant to blocking and dry to touch after physical drying; rather, radiation curing should yield a film which is distinguished by high chemical resistance and good mechanical strength.

EP-A 753531 describes urethane acrylate dispersions based on hydroxyl-group-containing polyester and polyepoxy acrylates. Although the films described therein are physically drying, the initial physical drying should be even greater for many applications. In addition, the films exhibit weaknesses towards solvents after radiation curing.

Aqueous, radiation-curable polyurethane dispersions based on hydroxyl-group-containing polyester and polyether acrylates are found in EP-A 872502. The coating systems yield physically drying films which, after radiation curing, exhibit unsatisfactory pendulum hardness. The resistance to solvents is likewise unsatisfactory.

EP-A 942022 describes urethane acrylate dispersions based on hydroxyl-group-containing polyester, polyether or polyurethane acrylates in combination with polyepoxy acrylates. The described coating systems yield physically drying clear lacquers. In formulations with a high pigment content in particular, the resistance to colouring agents and to solvents is not sufficient.

In all three mentioned patents, polyester polyols inter alia are used. They are preferably employed as flexibilising structural components by constructing the polyesters from long-chained and aliphatic polyols and/or diacids. Such flexibilising polyester polyols as structural units in a radiation-curable polyurethane dispersion lead to poor physical drying and to unsatisfactory resistance to colouring agents and solvents, in particular in pigmented formulations.

The object was to provide radiation-curable coating systems which permit rapid physical drying, have high blocking resistance after drying and, after radiation curing, permit very hard films having high resistance to chemicals. However, the films should not be brittle and should still be sufficiently flexible. This is to be the case for clear lacquers and pigmented lacquers.

Surprisingly, it has been found that radiation-curable, aqueous dispersions of polyurethane acrylates yield blocking-resistant coatings after a short drying time if they contain polyester polyols based on aromatic di- and/or tri-carboxylic acids and aliphatic diols having from 2 to 4 carbon atoms or aliphatic triols. In addition, the films of these dispersions, both as a clear lacquer and as a pigmented lacquer, achieve a high pendulum hardness after radiation curing and are found to be highly resistant to chemicals and colouring agents.

### EMBODIMENTS OF THE INVENTION

An embodiment of the present invention is a radiation-curable, aqueous dispersion based on polyurethane acrylates (i) comprising as structural components
A) an oligomeric or polymeric compound comprising an isocyanate-reactive group and a radically copolymerisable group;
B) optionally a monomeric compound other than A comprising a hydroxy functional group and a (meth)acrylate group;
C) a polyester polyol obtained from
   C1) an aliphatic diol comprising from 2 to 4 carbon atoms between the two OH functional groups of said aliphatic diol and/or an aliphatic triol, and
   C2) an aromatic di- and/or tri-carboxylic acid;
D) optionally a polyol other than A, B, and C;
E) a compound comprising an isocyanate-reactive group towards and a non-ionic group, an ionic group, or a group capable of forming an ionic group, wherein said compound has a dispersing action;
F) an organic polyisocyanate;
G) optionally a compound other than A, B, C, D, and E comprising an isocyanate-reactive group.

Another embodiment of the present invention is the above radiation-curable, aqueous dispersion, further comprising a reactive diluent (ii) comprising a radically polymerisable group.

Another embodiment of the present invention is the above radiation-curable, aqueous dispersion, wherein structural component C is used in an amount of from 5 to 75 weight %, wherein the sum of the amounts of components A, B, C, D, E, F, and G equals 100 weight %.

Another embodiment of the present invention is the above radiation-curable, aqueous dispersion, wherein structural component C has an OH number in the range of from 20 to 500 mg KOH/g of substance.

Another embodiment of the present invention is the above radiation-curable, aqueous dispersion, wherein structural component A is selected from the group consisting of polyester(meth)acrylates comprising hydroxyl groups, polyether(meth)acrylates comprising hydroxyl groups, polyether ester(meth)acrylates comprising hydroxyl groups, and polyepoxy(meth)acrylates comprising hydroxyl groups.

Another embodiment of the present invention is the above radiation-curable, aqueous dispersion, wherein component C1 is selected from the group consisting of 1,2-ethanediol, 1,2-propanediol, 1,3-propanediol, neopentyl glycol, 2-ethyl-2-butylpropanediol, 1,3-butanediol, 1,2-cyclohexanediol, 1,4-cyclohexanediol, 1,4-butanediol, trimethylolethane, trimethylolpropane, trimethylolbutane, glycerol, castor oil, and mixtures thereof and component C2 is selected from the group consisting of phthalic acid, phthalic anhydride, isophthalic acid, isophthalic anhydride, terephthalic acid, terephthalic anhydride, trimellitic acid, trimellitic anhydride, and mixtures thereof.

Another embodiment of the present invention is the above radiation-curable, aqueous dispersion, wherein component C1 is selected from the group consisting of 1,2-ethanediol, 1,2-propanediol, neopentyl glycol, trimethylolpropane, and mixtures thereof, and component C2 is selected from the group consisting of isophthalic acid, terephthalic acid, and mixtures thereof.

Another embodiment of the present invention is the above radiation-curable, aqueous dispersion, wherein structuralcomponent E is selected from the group consisting of 2-(2-amino-ethylamino)ethanesulfonic acid, 3-(cyclohexylamino)propane-1-sulfonic acid, the addition product of isophoronediamine and acrylic acid, hydroxypivalic acid, dimethylolpropionic acid, triethanolamine, tripropanolamine, N-methyldiethanolamine, N,N-dimethylethanolamine, monofunctional mixed polyalkylene oxide polyethers containing at least 40 mol % ethylene oxide units and no more than 60 mol % propylene oxide units, and mixtures thereof.

Another embodiment of the present invention is the above radiation-curable, aqueous dispersion, wherein structutal component F is selected from the group consisting of the polyisocyanates 1,6-hexamethylene diisocyanate, 1-isocyanato-3,3,5-trimethyl-5-isocyanatomethylcyclohexane, 4,4′-diisocyanato-dicyclohexylmethane, and mixtures thereof; homologues of 1-isocyanato-3,3,5-trimethyl-5-isocyanatomethylcyclohexane with biuret, carbodiimide, isocyanurate, allophanate, iminooxadiazinedione, and/or uretdione groups, oligomers of 1-isocyanato-3,3,5-trimethyl-5-isocyanatomethylcyclohexane with biuret, carbodiimide, isocyanurate, allophanate, iminooxadiazinedione, and/or uretdione groups, homologues of 4,4′-diisocyanato-dicyclohexylmethane with biuret, carbodiimide, isocyanurate, allophanate, iminooxadiazinedione, and/or uretdione groups, oligomers of 4,4′-diisocyanato-dicyclohexylmethane with biuret, carbodiimide, isocyanurate, allophanate, iminooxadiazinedione, and/or uretdione groups, and mixtures thereof; and mixtures of said homologues and/or said oligomers with said polyisocyanates.

Yet another embodiment of the present invention is process for preparing the above radiation-curable, aqueous dispersion, comprising
reacting components A, B, C, D, and E in one or more reaction steps with component F to obtain a polyurethane acrylate prepolymer (i), wherein a neutralising agent for producing ionic groups is optionally added before, during, or after the preparation of said polyurethane acrylate prepolymer;
adding water to said polyurethane acrylate prepolymer or converting said polyurethane acrylate prepolymer into an aqueous initial charge to obtain a dispersion; and
optionally chain extending said polyurethane acrylate prepolymer with component G before, during or after obtaining said dispersion.

Another embodiment of the present invention is the above process, wherein the molar ratios of isocyanate groups in F to isocyanate-reactive groups in A, B, C, D and E is from 0.8:1 to 2.5:1.

Another embodiment of the present invention is the above process, wherein one more reactive diluents having at least one radically polymerisable group (component ii) is/are added as a further component.

Yet another embodiment of the present invention is a coating, lacquer, or adhesive comprising the above radiation-curable, aqueous dispersion.

Yet another embodiment of the present invention is a coating composition comprising the above radiation-curable, aqueous dispersion, a crosslinker based on an amino resin, a blocked polyisocyanate, a non-blocked polyisocyanate, a polyaziridine and/or a polycarbodiimide, and/or a further dispersion.

Yet another embodiment of the present invention is a substrate coated with above coating composition.

### DESCRIPTION OF THE INVENTION

The invention relates to radiation-curable, aqueous dispersions based on polyurethane acrylates (i) containing as structural components
A) one or more oligomeric or polymeric compounds having at least one group reactive towards isocyanate and at least one radically copolymerisable group,
B) optionally one or more monomeric compounds, other than A, having a hydroxy functional group and at least one (meth)acrylate group,
C) polyester polyols obtainable from
   C1) aliphatic diols having from 2 to 4 carbon atoms between the two OH functional groups and/or aliphatic triols and
   C2) aromatic di- and/or tri-carboxylic acids,
D) optionally polyols other than A to C,
E) one or more compounds having at least one group reactive towards isocyanate and, in addition, non-ionic groups, ionic groups or groups capable of forming ionic groups, which have a dispersing action for the polyurethane dispersion,
F) organic polyisocyanates,
G) optionally compounds, other than A to E, having at least one group reactive towards isocyanate.

Within the scope of this specification, “(meth)acrylate” denotes corresponding acrylate or methacrylate functional groups or a mixture of the two.

The dispersion optionally contains a component ii, component ii being reactive diluents containing at least one radically polymerisable group.

Structural components A and optionally B and/or optionally component ii are used in amounts such that the content of radically copolymerisable double bonds is from 0.5 to 6.0, preferably from 1.0 to 5.5, particularly preferably from 1.5 to 5.0 mol/kg of non-aqueous constituents of the dispersion.

Structural component C is used in an amount of from 5 to 75 wt. %, preferably from 10 to 50 wt. %, particularly preferably from 10 to 40 wt. %, the sum of the amounts of components A to G being 100 wt. %.

Component ii is used in an amount of from 0 to 65 wt. %, preferably from 0 to 40 wt. %, particularly preferably from 0 to 35 wt. %, the sum of the amounts of components i and ii being 100 wt. %.

Component A comprises oligomeric or polymeric compounds having at least one group reactive towards isocyanate and at least one radically copolymerisable group.

These oligomers and polymers containing unsaturated groups are, for example, polyester (meth)acrylates, polyether(meth)acrylates, polyether ester(meth)acrylates, unsaturated polyesters having allyl ether structural units, polyepoxy(meth)acrylates and combinations of the mentioned compounds.

Of the polyester(meth)acrylates, there are used as component A the hydroxyl-group-containing polyester(meth)acrylates having an OH number in the range from 15 to 300 mg KOH/g of substance, preferably from 60 to 200 mg KOH/g of substance. In the preparation of the hydroxy-functional polyester(meth)acrylates (A), a total of 7 groups of monomer constituents can be used:

The first group (a) contains alkanediols or diols or mixtures thereof. The alkanediols have a molecular weight in the range from 62 to 286 g/mol. Preference is given to alkanediols selected from the group ethanediol, 1,2- and 1,3-propanediol, 1,2-, 1,3- and 1,4-butanediol, 1,5-pentanediol, 1,6-hexanediol, neopentyl glycol, cyclohexane-1,4-dimethanol, 1,2- and 1,4-cyclohexanediol, 2-ethyl-2-butylpropanediol. Preferred diols are diols containing ether oxygen, such as diethylene glycol, triethylene glycol, tetraethylene glycol, dipropylene glycol, tripropylene glycol, polyethylene, polypropylene or polybutylene glycols having a molecular weight in the range from 200 to 4000 g/mol, preferably from 300 to 2000 g/mol, particularly preferably from 450 to 1200 g/mol. Reaction products of the above-mentioned diols with ε-caprolactone or other lactones can also be used as diols.

The second group (b) contains tri- and higher-hydric alcohols having a molecular weight in the range from 92 to 254 g/mol and/or polyethers started on these alcohols. Particularly preferred tri- and higher-hydric alcohols are glycerol, trimethylolpropane, pentaerythritol, dipentaerythritol and sorbitol. A particularly preferred polyether is the reaction product of 1 mol of trimethylolpropane with 4 mol of ethylene oxide.

The third group (c) contains monoalcohols. Particularly preferred monoalcohols are selected from the group ethanol, 1- and 2-propanol, 1- and 2-butanol, 1-hexanol, 2-ethylhexanol, cyclohexanol and benzyl alcohol.

The fourth group (d) contains dicarboxylic acids having a molecular weight in the range from 104 to 600 g/mol and/or anhydrides thereof. Preferred dicarboxylic acids and anhydrides thereof are selected from the group phthalic acid, phthalic anhydride, isophthalic acid, tetrahydrophthalic acid, tetrahydrophthalic anhydride, hexahydrophthalic acid, hexahydrophthalic anhydride, cyclohexanedicarboxylic acid, maleic anhydride, fumaric acid, malonic acid, succinic acid, succinic anhydride, glutaric acid, adipic acid, pimelic acid, suberic acid, sebacic acid, dodecanedioic acid, hydrogenated dimers of the fatty acids as listed under the sixth group (f).

The fifth group (e) contains trimellitic acid and trimellitic anhydride.

The sixth group (f) contains monocarboxylic acids, for example benzoic acid, cyclohexanecarboxylic acid, 2-ethylhexanoic acid, caproic acid, caprylic acid, capric acid, lauric acid, and natural and synthetic fatty acids, for example lauric, myristic, palmitic, margaric, stearic, behenic, cerotic, palmitoleic, oleic, icosenic, linoleic, linolenic and arachidonic acid.

The seventh group (g) contains acrylic acid, methacrylic acid and/or dimeric acrylic acid. Suitable hydroxyl-group-containing polyester(meth)acrylates (A) contain the reaction product of at least one constituent from group (a) or (b) with at least one constituent from group (d) or (e) and at least one constituent from group (g).

Particularly preferred constituents from group (a) are selected from the group ethanediol, 1,2- and 1,3-propanediol, 1,4-butanediol, 1,6-hexanediol, neopentyl glycol, cyclohexane-1,4-dimethanol, 1,2- and 1,4-cyclohexanediol, 2-ethyl-2-butylpropanediol, diols containing ether oxygen, selected from the group diethylene glycol, triethylene glycol, tetraethylene glycol, dipropylene glycol and tripropylene glycol. Preferred constituents from group (b) are selected from the group glycerol, trimethylolpropane, pentaerythritol, and the reaction product of 1 mol of trimethylolpropane with 4 mol of ethylene oxide. Particularly preferred constituents from groups (d) and (e) are selected from the group phthalic anhydride, isophthalic acid, tetrahydrophthalic anhydride, hexahydrophthalic acid, hexahydrophthalic anhydride, maleic anhydride, fumaric acid, succinic anhydride, glutaric acid, adipic acid, dodecanedioic acid, hydrogenated dimers of the fatty acids as listed under the 6th group (f), and trimellitic anhydride. A preferred constituent from group (g) is acrylic acid.

Groups having a dispersing action that are generally known from the prior art can optionally also be incorporated into the polyester(meth)acrylates. For example, polyethylene glycols and/or methoxypolyethylene glycols can be used proportionately as the alcohol component. As compounds there can be used alcohol-started polyethylene glycols, polypropylene glycols and block copolymers thereof, as well as the monomethyl ethers of these polyglycols. Polyethylene glycol monomethyl ether having a molecular weight in the range from 500 to 1500 g/mol is particularly suitable.

It is also possible, after the esterification, to react some of the non-esterified carboxyl groups that are still free, in particular those of (meth)acrylic acid, with mono-, di- or poly-epoxides. Preferred epoxides are the glycidyl ethers of monomeric, oligomeric or polymeric bisphenol A, bisphenol F, hexanediol and/or butanediol or ethoxylated and/or propoxylated derivatives thereof. This reaction can be used in particular to increase the OH number of the polyester(meth)acrylate, because an OH group forms in each case in the epoxide-acid reaction. The acid number of the resulting product is from 0 to 20 mg KOH/g, preferably from 0 to 10 mg KOH/g and particularly preferably from 0 to 5 mg KOH/g of substance. The reaction is preferably catalysed by catalysts such as triphenylphosphine, thiodiglycol, ammonium and/or phosphonium halides and/or zirconium or tin compounds, such as tin(II) ethylhexanoate.

The preparation of polyester(meth)acrylates is described on page 3, line 25 to page 6, line 24 of DE-A 4 040 290, on page 5, line 14 to page 11, line 30 of DE-A 3 316 592 and on pages 123 to 135 of P. K. T. Oldring (Ed.) in Chemistry & Technology of UV & EB Formulations For Coatings, Inks & Paints, Vol. 2, 1991, SITA Technology, London.

Also suitable as component A are hydroxyl-group-containing polyether(meth)acrylates, which are formed in the reaction of acrylic acid and/or methacrylic acid with polyethers, for example homopolymers, copolymers or block copolymers of ethylene oxide, propylene oxide and/or tetrahydrofuran on any desired hydroxy- and/or amine-functional starter molecules, for example trimethylolpropane, ethylene glycol, propylene glycol, diethylene glycol, dipropylene glycol, glycerol, pentaerythritol, neopentyl glycol, butanediol and hexanediol.

Also suitable as component A) are the hydroxyl-group-containing epoxy(meth)acrylates known per se having an OH number in the range from 20 to 300 mg KOH/g, preferably from 100 to 280 mg KOH/g, particularly preferably from 150 to 250 mg KOH/g, or hydroxyl-group-containing polyurethane(meth)acrylates having an OH number in the range from 20 to 300 mg KOH/g, preferably from 40 to 150 mg KOH/g, particularly preferably from 50 to 100 mg KOH/g. Such compounds are likewise described on pages 37 to 56 in P. K. T. Oldring (Ed.), Chemistry & Technology of UV & EB Formulations For Coatings, Inks & Paints, Vol. 2, 1991, SITA Technology, London. Hydroxyl-group-containing epoxy(meth)acrylates are based in particular on reaction products of acrylic acid and/or methacrylic acid with epoxides (glycidyl compounds) of monomeric, oligomeric or polymeric bisphenol A, bisphenol F, hexanediol and/or butanediol or ethoxylated and/or propoxylated derivatives thereof.

Preferred oligomers and polymers (A) containing unsaturated groups are compounds selected from the group polyester(meth)acrylates, polyether(meth)acrylates, polyether ester(meth)acrylates and polyepoxy(meth)acrylates, which, in addition to the unsaturated groups, also contain hydroxyl groups.

Component B comprises monohydroxy-functional, (meth)acrylate-group-containing alcohols. Such monohydroxy-functional, (meth)acrylate-group-containing alcohols are, for example, 2-hydroxyethyl(meth)acrylate, caprolactone-extended modifications of 2-hydroxyethyl(meth)acrylate, such as Pemcure® 12A (Cognis, Del.), 2-hydroxypropyl (meth)acrylate, 4-hydroxybutyl(meth)acrylate, 3-hydroxy-2,2-dimethylpropyl(meth)-acrylate, the on average monohydroxy-functional di-, tri- or penta-(meth)acrylates of polyhydric alcohols such as trimethylolpropane, glycerol, pentaerythritol, ditrimethylol-propane, dipentaerythritol, ethoxylated, propoxylated or alkoxylated trimethylolpropane, glycerol, pentaerythritol, ditrimethylolpropane, dipentaerythritol, or commercial mixtures thereof.

In addition, alcohols obtainable from the reaction of double-bond-containing acids with optionally double-bond-containing, monomeric epoxide compounds can also be used as monohydroxy-functional, (meth)acrylate-group-containing alcohols. Preferred reaction products are selected from the group (meth)acrylic acid with glycidyl(meth)acrylate or the glycidyl ester of tertiary, saturated monocarboxylic acid. Tertiary, saturated monocarboxylic acids are, for example, 2,2-dimethylbutyric acid, ethylmethylbutyric acid, ethylmethylpentanoic acid, ethylmethylhexanoic acid, ethylmethylheptanoic acid and/or ethylmethyloctanoic acid.

Particularly preferred monohydroxy-functional, (meth)acrylate-group-containing alcohols are 2-hydroxyethyl(meth)acrylate, 2-hydroxypropyl(meth)acrylate, pentaerythritol triacrylate, dipentaerythritol pentaacrylate and the addition product of ethylmethylheptanoic acid glycidyl ester with (meth)acrylic acid, and commercial mixtures thereof.

2-Hydroxyethyl(meth)acrylate is most particularly preferred.

The monohydroxy-functional, (meth)acrylate-group-containing alcohols (B) can be used either on their own or in the form of mixtures.

Component C comprises hydroxy-functional polyesters composed of aliphatic diols having from 2 to 4 carbon atoms between the two OH functional groups (component C1), for example 1,2-ethanediol, 1,2-propanediol, 1,3-propanediol, neopentyl glycol, 2-ethyl-2-butylpropanediol, 1,3-butanediol, 1,2- and 1,4-cyclohexanediol and/or 1,4-butanediol and/or aliphatic triols (component C1), for example trimethylolethane, trimethylolpropane, trimethylolbutane, glycerol and/or castor oil, as well as aromatic di- and/or tri-carboxylic acids (component C2), for example phthalic acid, phthalic anhydride, isophthalic acid, terephthalic acid and/or trimellitic acid, as well as the anhydrides of the mentioned acids.

The aromatic di- and/or tri-acids (C2) can also be present in admixture with aliphatic, unsaturated diacids, for example maleic acid, maleic anhydride, fumaric acid, tetrahydrophthalic acid and/or tetrahydrophthalic anhydride.

Preferred structural units for the polyester polyols (C) are 1,2-ethanediol, 1,2-propanediol, 1,3-propanediol, neopentyl glycol, trimethylolpropane, glycerol and/or castor oil (C1), and phthalic acid, phthalic anhydride, isophthalic acid and/or terephthalic acid (C2).

Particularly preferred structural units for the polyester polyols (C) are 1,2-ethanediol, 1,2-propanediol, neopentyl glycol and/or trimethylolpropane (C1), and isophthalic acid and/or terephthalic acid (C2).

Structural component C has an OH number of from 20 to 500, preferably from 40 to 400 and particularly preferably from 70 to 390 mg KOH/g of substance.

Component D comprises monomeric mono-, di- and/or tri-ols, in each case having a molecular weight of from 32 to 240 g/mol, for example methanol, ethanol, 1-propanol, 1-butanol, 1-pentanol, 1-hexanol, 2-propanol, 2-butanol, 2-ethylhexanol, ethylene glycol, diethylene glycol, triethylene glycol, tetraethylene glycol, dipropylene glycol, tripropylene glycol, 1,2-propanediol, 1,3-propanediol, 1,4-butanediol, neopentyl glycol, 2-ethyl-2-butylpropanediol, trimethylpentanediol, 1,3-butylene glycol, 1,4-cyclohexanedimethanol, 1,6-hexanediol, 1,2- and 1,4-cyclohexanediol, hydrogenated bisphenol A (2,2-bis(4-hydroxycyclohexyl)propane), 2,2-dimethyl-3-hydroxypropionic acid 2,2-dimethyl-3-hydroxypropyl ester, glycerol, trimethylolethane, trimethylolpropane and/or trimethylolbutane. Neopentyl glycol, 1,4-butanediol, 1,4-cyclohexanedimethanol, 1,6-hexanediol and/or trimethylolpropane are preferred.

Component D can further comprise oligomeric and/or polymeric, hydroxy-functional compounds, although these are less preferred because they result in a flexibilisation which at least partly cancels out the hardening effect of component C). These oligomeric and/or polymeric, hydroxy-functional compounds are, for example, polyesters, polycarbonates, C2-, C3- and/or C4-polyethers, polyether esters, polycarbonate polyesters having a functionality of from 1.0 to 3.0, in each case having a weight-average molar mass M, in the range from 300 to 4000 g/mol, preferably from 500 to 2500 g/mol.

Hydroxy-functional polyester alcohols are those based on aliphatic and/or cycloaliphatic dicarboxylic acids with monomeric di- and tri-ols, as have already been mentioned as component D, as well as lactone-based polyester alcohols.

Hydroxy-functional polyetherols are obtainable, for example, by polymerisation of cyclic ethers or by reaction of alkylene oxides with a starter molecule.

Hydroxy-functional polycarbonates are hydroxyl-terminated polycarbonates, the polycarbonates obtainable by reaction of diols, lactone-modified diols or bisphenols, for example bisphenol A, with phosgene or carbonic acid diesters, such as diphenyl carbonate or dimethyl carbonate.

Component (E) comprises ionic groups, which can be of either cationic or anionic nature, and/or non-ionic hydrophilic groups. Compounds having a cationic, anionic or non-ionic dispersing action are those which contain, for example, sulfonium, ammonium, phosphonium, carboxylate, sulfonate, phosphonate groups or groups which can be converted into the above-mentioned groups by salt formation (potentially ionic groups), or polyether groups, and which can be incorporated into the macromolecules by isocyanate-reactive groups that are present. Preferred isocyanate-reactive groups that are suitable are hydroxyl and amine groups.

Suitable anionic or potentially anionic compounds (E) are, for example, mono- and di-hydroxycarboxylic acids, mono- and di-aminocarboxylic acids, mono- and di-hydroxysulfonic acids, mono- and di-aminosulfonic acids, mono- and di-hydroxyphosphonic acids, mono- and di-aminophosphonic acids and their salts, such as dimethylolpropionic acid, dimethylolbutyric acid, hydroxypivalic acid, N-(2-aminoethyl)-alanine, 2-(2-amino-ethylamino)-ethanesulfonic acid, ethylenediamine-propyl- or -butyl-sulfonic acid, 1,2- or 1,3-propylenediamine-ethylsulfonic acid, 3-(cyclohexylamino)propane-1-sulfonic acid, malic acid, citric acid, glycolic acid, lactic acid, glycine, alanine, taurine, lysine, 3,5-diaminobenzoic acid, an addition product of isophoronediamine (1-amino-3,3,5-trimethyl-5-aminomethylcyclohexane or IPDA) and acrylic acid (EP-A 916 647, Example 1), the adduct of sodium bisulfite with 2-butene-1,4-diol, polyether sulfonate, and the propoxylated adduct of 2-butenediol and NaHSO3, as is described in DE-A 2 446 440 on pages 5-9, formulae I-III. Suitable cationic structural units or structural units which can be converted into cationic groups are, for example, ethanolamine, diethanolamine, triethanolamine, 2-propanolamine, dipropanolamine, tripropanolamine, N-methylethanolamine, N-methyldiethanolamine and N,N-dimethylethanolamine.

Particularly preferred ionic or potentially ionic compounds (E) are those which contain carboxyl and/or sulfonate groups as ionic groups, such as 2-(2-amino-ethylamino-) ethanesulfonic acid, 3-(cyclohexylamino)propane-1-sulfonic acid, the addition product of isophoronediamine and acrylic acid (EP 916 647 A1, Example 1), hydroxypivalic acid and/or dimethylolpropionic acid, as well as those which contain tertiary amines, such as triethanolamine, tripropanolamine, N-methyldiethanolamine and/or N,N-dimethylethanolamine.

Most particularly preferred ionic or potentially ionic compounds (E) are hydroxypivalic acid and/or dimethylolpropionic acid.

Suitable compounds having a non-ionic hydrophilising action are, for example, polyoxyalkylene ethers which contain at least one hydroxy or amino group. These polyethers contain an amount of from ≧30 wt. % to ≦100 wt. % structural units derived from ethylene oxide. There are suitable polyethers having a linear structure and a functionality of from ≧1 to ≦3, but also compounds of the general formula (I)

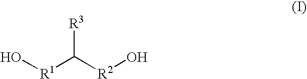

in which
R1 and R2 each independently of the other denotes a divalent aliphatic, cycloaliphatic or aromatic radical having from 1 to 18 carbon atoms, which can be interrupted by oxygen and/or nitrogen atoms, and R3 represents an alkoxy-terminated polyethylene oxide radical.

Compounds having a non-ionic hydrophilising action are, for example, also monovalent polyalkylene oxide polyether alcohols having in the statistical mean from ≧5 to ≦70, preferably from ≧7 to ≦55 ethylene oxide units per molecule, as are obtainable by alkoxylation of suitable starter molecules.

Suitable starter molecules are, for example, saturated monoalcohols such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxymethyloxetane or tetrahydrofurfuryl alcohol, diethylene glycol monoalkyl ethers, for example diethylene glycol monobutyl ether, unsaturated alcohols such as allyl alcohol, 1,1-dimethylallyl alcohol or oleic alcohol, aromatic alcohols such as phenol, the isomeric cresols or methoxyphenols, araliphatic alcohols such as benzyl alcohol, anisic alcohol or cinnamic alcohol, secondary monoamines such as dimethylamine, diethylamine, dipropylamine, diisopropylamine, dibutylamine, bis-(2-ethylhexyl)-amine, N-methyl- and N-ethyl-cyclohexylamine or dicyclohexylamine, as well as heterocyclic secondary amines such as morpholine, pyrrolidine, piperidine or 1H-pyrazole. Preferred starter molecules are saturated monoalcohols. Diethylene glycol monobutyl ether is particularly preferably used as starter molecule.

Suitable alkylene oxides for the alkoxylation reaction are in particular ethylene oxide and propylene oxide, which can be used in the alkoxylation reaction in any desired sequence or in admixture.

The polyalkylene oxide polyether alcohols are either pure polyethylene oxide polyethers or mixed polyalkylene oxide polyethers, the alkylene oxide units of which comprise ≧30 mol %, preferably ≧40 mol %, ethylene oxide units. Preferred non-ionic compounds are monofunctional mixed polyalkylene oxide polyethers containing ≧40 mol % ethylene oxide units and ≦60 mol % propylene oxide units.

The acids mentioned under component E are converted into the corresponding salts by reaction with neutralising agents, such as triethylamine, ethyldiisopropylamine, dimethylcyclohexylamine, dimethylethanolamine, ammonia, N-ethylmorpholine, LiOH, NaOH and/or KOH. The degree of neutralisation is preferably from 50 to 125%.

The bases mentioned under component E are converted into the corresponding salts by reaction with neutralising agents, for example inorganic acids, for example hydrochloric acid, phosphoric acid and/or sulfuric acid, and/or organic acids, for example formic acid, acetic acid, lactic acid, methanesulfonic acid, ethanesulfonic acid and/or p-toluenesulfonic acid. The degree of neutralisation is preferably from 50 to 125%.

The compounds mentioned under component E can also be used as mixtures.

Ionic hydrophilisation and the combination of ionic and non-ionic hydrophilisation are preferred over purely non-ionic hydrophilisation.

Component F comprises polyisocyanates selected from the group comprising aromatic, araliphatic, aliphatic or cycloaliphatic polyisocyanates or mixtures of such polyisocyanates, for example 1,3-cyclohexane diisocyanate, 1-methyl-2,4-diisocyanato-cyclohexane, 1-methyl-2,6-diisocyanato-cyclohexane, tetramethylene diisocyanate, 4,4′-diisocyanatodiphenylmethane, 2,4′-diisocyanatodiphenylmethane, 2,4-diisocyanatotoluene, 2,6-diisocyanatotoluene, α,α,α,′α,′-tetra-methyl-m- or -p-xylylene diisocyanate, 1,6-hexamethylene diisocyanate, 1-isocyanato-3,3,5-trimethyl-5-isocyanatomethylcyclohexane (isophorone diisocyanate or IPDI), 4,4′-diisocyanato-dicyclohexylmethane, 4-isocyanatomethyl-1,8-octane diisocyanate (triisocyanatononane, TIN) (EP-A 928 799) and mixtures thereof. Also suitable are homologues or oligomers of the mentioned polyisocyanates with biuret, carbodiimide, isocyanurate, allophanate, iminooxadiazinedione and/or uretdione groups, mixtures thereof with one another and mixtures with the polyisocyanates mentioned above. Preference is given to 1,6-hexamethylene diisocyanate, 1-isocyanato-3,3,5-trimethyl-5-isocyanatomethylcyclohexane (isophorone diisocyanate or IPDI) and 4,4′-diisocyanato-dicyclohexylmethane and mixtures thereof with one another. Preference is given also to homologues or oligomers of 1-isocyanato-3,3,5-trimethyl-5-isocyanatomethylcyclohexane (isophorone diisocyanate or IPDI) and 4,4′-diisocyanato-dicyclohexylmethane with biuret, carbodiimide, isocyanurate, allophanate, iminooxadiazinedione and/or uretdione groups, mixtures thereof with one another and mixtures with the preferred polyisocyanates mentioned above.

In order to increase the molar mass, mono- and di-amines and/or mono- or di-functional amino alcohols are used as component G. Preferred diamines are those which are more reactive to the isocyanate groups than water, because the extension of the polyester urethane(meth)acrylate optionally takes place in an aqueous medium. The diamines are particularly preferably selected from the group ethylenediamine, 1,6-hexamethylenediamine, isophoronediamine, 1,3-, 1,4-phenylenediamine, 4,4′-diphenylmethanediamine, piperazine, amino-functional polyethylene oxides, amino-functional polypropylene oxides (known by the name Jeffamin® D series [Huntsman Corp. Europe, Zavantem, Belgium]) and hydrazine. Ethylenediamine is most particularly preferred.

Preferred monoamines are selected from the group butylamine, ethylamine and amines of the Jeffamin® M series (Huntsman Corp. Europe, Zavantem, Belgium), amino-functional polyethylene oxides, amino-functional polypropylene oxides and/or amino alcohols.

Component ii comprises reactive diluents, which are to be understood as being compounds that contain at least one radically polymerisable group, preferably acrylate and methacrylate groups, and preferably no groups reactive towards isocyanate or hydroxy groups.

Preferred compounds II contain from 2 to 6, particularly preferably from 4 to 6, (meth)acrylate groups.

Particularly preferred compounds ii have a boiling point of more than 200° C. at normal pressure.

Reactive diluents are described generally in P. K. T. (Wring (editor), Chemistry & Technology of UV & EB Formulations for Coatings, Inks & Paints, Vol. II, Chapter III: Reactive Diluents for UV & EB Curable Formulations, Wiley and SITA Technology, London 1997.

Reactive diluents are, for example, the following alcohols esterified completely by (meth)acrylic acid: methanol, ethanol, 1-propanol, 1-butanol, 1-pentanol, 1-hexanol, 2-propanol, 2-butanol, 2-ethylhexanol, dihydrodicyclopentadienol, tetrahydrofurfuryl alcohol, 3,3,5-trimethylhexanol, octanol, decanol, dodecanol, ethylene glycol, diethylene glycol, triethylene glycol, tetraethylene glycol, dipropylene glycol, tripropylene glycol, 1,2-propanediol, 1,3-propanediol, 1,4-butanediol, neopentyl glycol, 2-ethyl-2-butylpropanediol, trimethylpentanediol, 1,3-butylene glycol, 1,4-cyclohexanedimethanol, 1,6-hexanediol, 1,2- and 1,4-cyclohexanediol, hydrogenated bisphenol A (2,2-bis(4-hydroxycyclohexyl)propane), glycerol, trimethylolethane, trimethylolpropane, trimethylolbutane, pentaerythritol, ditrimethylolpropane, dipentaerythritol, sorbitol and also ethoxylated and/or propoxylated derivatives of the mentioned alcohols, and the commercial mixtures formed in the (meth)acrylation of the above-mentioned compounds.

Component ii is preferably selected from the group comprising (meth)acrylates of tetrols and hexyls, such as (meth)acrylates of pentaerythritol, ditrimethylolpropane, dipentaerythritol, sorbitol, ethoxylated, propoxylated or alkoxylated pentaerythritol, ditrimethylolpropane, dipentaerythritol, sorbitol, and also ethoxylated and/or propoxylated derivatives of the mentioned alcohols, and the commercial mixtures formed in the (meth)acrylation of the above-mentioned compounds.

For the preparation of the dispersions according to the invention it is possible to use all the processes known from the prior art, such as the emulsifier/shear force, acetone, prepolymer mixing, melt emulsifying, ketimine and spontaneous solids dispersing processes or processes derived therefrom. A summary of these methods is to be found in Methoden der Organischen Chemie, Houben-Weyl, 4th Edition, Volume E20/Part 2 on page 1682, Georg Thieme Verlag, Stuttgart, 1987. The melt emulsifying and the acetone process are preferred. The acetone process is particularly preferred.

The invention also provides a process for the preparation of radiation-curable, aqueous dispersions based on polyurethane acrylates (i), characterised in that a polyurethane acrylate prepolymer (i) is obtained by reacting components A-E in one or more reaction steps with component F, wherein a neutralising agent for producing the ionic groups necessary for the dispersion can be added before, during or after the preparation of the prepolymer, followed by a dispersing step by addition of water to the prepolymer or conversion of the prepolymer into an aqueous initial charge, wherein a chain extension by means of component F can take place before, during or after the dispersion.

The invention also provides a process according to the above description in which one or more reactive diluents containing at least one radically polymerisable group (component ii) are added.

In order to prepare the reaction product, components A to E are placed in the reactor and optionally diluted with acetone. Component ii can optionally also be added to components A to E. In order to accelerate the isocyanate addition, isocyanate addition reaction catalysts, for example triethylamine, 1,4-diazabicyclo-[2,2,2]-octane, tin dioctoate or dibutyltin dilaurate, can be added and the mixture can be heated in order to enable the reaction to start. Temperatures of from 30 to 60° C. are generally necessary for that purpose. The polyisocyanate(s) (F) is/are then metered in. The reverse variant is also possible, the polyisocyanates (F) then being placed in the reaction vessel and the isocyanate-reactive components A) to E) being added. Components A to E can also be added in succession and in any sequence. A stepwise reaction of the components is also possible, that is to say the separate reaction of component F with one or more isocyanate-reactive components A, B, C, D and/or E before the resulting adduct is reacted further with the components that have not yet been used.

In order to monitor the reaction, the NCO content is determined at regular intervals by titration, infrared or near-infrared spectroscopy.

The molar ratios of isocyanate groups in F to isocyanate-reactive groups in A to E are from 0.8:1 to 2.5:1, preferably from 1.2:1 to 1.5:1.

After the preparation of the product (i) from components A to F by the process according to the invention, the salt formation of the compound E centres having an ionic dispersing action is effected if it was not carried out in the starting molecules. Where component E contains acidic groups, bases selected from the group triethylamine, ethyldiisopropylamine, dimethylcyclohexylamine, dimethylethanolamine, ammonia, N-ethylmorpholine, LiOH, NaOH and/or KOH are preferably used. Where component E contains basic groups, acids, for example lactic acid, acetic acid, phosphoric acid, hydrochloric acid and/or sulfuric acid, are preferably used. If compounds that contain only ether groups are used as component E, this neutralising step is omitted.

A reactive diluent (ii) or a mixture of reactive diluents (ii) can then optionally be added. The addition of component ii preferably takes place at from 30 to 45° C. As soon as component ii has dissolved, the final reaction step is optionally carried out, in which an increase in the molar mass and the formation of the dispersions required for the coating system according to the invention take place in the aqueous medium: The polyurethane, synthesised from components A, B, C, D, E and F, and optionally the reactive diluent(s) (ii), optionally dissolved in acetone, are either introduced, with vigorous stirring, into the dispersing water containing the amine(s) (G) or, conversely, the dispersing water/amine mixture is stirred into the polyurethane solution. In addition, the dispersions contained in the coating system according to the invention form. The amount of amine (G) used depends on the unreacted isocyanate groups that are still present. Reaction of the isocyanate groups that are still free with the amine (G) can take place to the extent of from 35% to 150%. Where a sub-stoichiometric amount of amine (G) is used, isocyanate groups that are still free slowly react to completion with water. If an excess of amine (G) is used, no unreacted isocyanate groups are present and an amine-functional polyurethane is obtained. Preferably from 80% to 110%, particularly preferably from 90% to 100%, of the isocyanate groups that are still free are reacted with the amine (G).

In a further variant it is possible to carry out the molar mass increase by the amine (G) in the acetone solution, that is to say before the dispersion, and optionally before or after the addition of the reactive diluents (ii).

In a further variant it is possible to carry out the molar mass increase by the amine (G) after the dispersing step.

If desired, the organic solvent—where present—can be removed by distillation. The dispersions then have a solids content of from 20 to 60 wt. %, in particular from 30 to 58 wt. %.

It is also possible to carry out the dispersing step and the distillation step in parallel, that is to say simultaneously or at least partly simultaneously.

The invention also provides the use of the radiation-curable, aqueous dispersions according to the invention in the production of coatings, in particular of lacquers and adhesives.

After removal of the water by conventional methods, such as heat, thermal radiation, moving, optionally dried air and/or microwaves, the dispersions according to the invention yield clear films. The films cure by subsequent radiation- and/or radical-induced crosslinking to give particularly high-quality lacquer coatings which are resistant to chemicals.

For radiation-induced polymerisation, electromagnetic radiation is suitable, the energy of which, optionally with the addition of suitable photoinitators, is sufficient to effect radical polymerisation of (meth)acrylate double bonds.

Radiation-induced polymerisation is preferably carried out by means of radiation having a wavelength of less than 400 nm, such as UV, electron, X-ray or gamma radiation. UV radiation is particularly preferred, curing with UV radiation being initiated in the presence of photoinitiators. With regard to photoinitiators, a distinction is made in principle between two types, unimolecular (type I) and bimolecular (type II). Suitable (type I)-systems are aromatic ketone compounds, for example benzophenones in combination with tertiary amines, alkylbenzophenones, 4,4′-bis(dimethylamino)benzophenone (Michler's ketone), anthrone and halogenated benzophenones, or mixtures of the mentioned types. Also suitable are (type II)-initiators, such as benzoin and its derivatives, benzil ketals, acylphosphine oxides, 2,4,6-trimethyl-benzoyl-diphenylphosphine oxide, bisacylphosphine oxides, phenylglyoxylic acid esters, camphorquinone, α-aminoalkylphenones, α,α-dialkoxyacetophenones and α-hydroxyalkylphenones. Photoinitiators which can readily be incorporated into aqueous coating compositions are preferred. Such products are, for example, Irgacure® 500 (a mixture of benzophenone and (1-hydroxycyclohexyl)phenyl ketone, Ciba, Lampertheim, Del.), Irgacure® 819 DW (phenylbis-(2,4,6-trimethylbenzoyl)-phosphine oxide, Ciba, Lampertheim, Del.), Esacure® KIP EM (oligo-[2-hydroxy-2-methyl-1-[4-(1-methylvinyl)-phenyl]-propanone], Lamberti, Aldizzate, Italy). It is also possible to use mixtures of these compounds.

Polar solvents, for example acetone and isopropanol, can also be used for the incorporation of the photoinitiators.

The UV curing is advantageously carried out at from 30 to 70° C., because the degree of conversion of (meth)acrylate groups tends to be increased at a higher temperature. This can result in better resistance properties. However, possible heat sensitivity of the substrate must be taken into account in the UV curing, so that optimum curing conditions for a particular coating composition/substrate combination are to be determined by the person skilled in the art in simple preliminary tests.

The radiation source(s) which initiate(s) the radical polymerisation can be stationary, and the coated substrate is moved past the radiation source by suitable conventional devices, or the radiation sources are movable by conventional devices, so that the coated substrates are stationary during the curing. It is also possible to carry out the irradiation in chambers, for example, in which case the coated substrate is introduced into the chamber, the radiation source is then switched on for a specific period of time, and the substrate is removed from the chamber again after the irradiation.

Curing is optionally carried out under an inert gas atmosphere, that is to say with the exclusion of oxygen, in order to prevent inhibition of the radical crosslinking by oxygen.

In the case of thermal radical curing, water-soluble peroxides or aqueous emulsions of water-insoluble initiators are suitable. These radical formers can be combined with accelerators in known manner.

The coating systems according to the invention can be applied to a very wide variety of substrates by conventional techniques, preferably by spraying, roller coating, flood coating, printing, knife application, pouring, spreading and dipping.

It is in principle possible to lacquer or coat any substrates with the coating systems according to the invention. Preferred substrates are selected from the group consisting of mineral substrates, wood, derived timber products, furniture, parquet, doors, window frames, metal objects, plastics, paper, cardboard, cork, mineral substrates, textiles or leather. They are suitable as a base coat and/or as a top coat. In addition, the coating systems according to the invention can also be used in or as adhesives, for example in contact adhesives, in heat-activated adhesives or in laminating adhesives.

The coating systems according to the invention can be used on their own or in binder mixtures with other dispersions. These can be dispersions which likewise contain unsaturated groups, for example polyester-, polyurethane-, polyepoxy(meth)acrylate-, polyether-, polyamide-, polysiloxane-, polycarbonate-, epoxy acrylate-, polyester acrylate-, polyurethane polyacrylate- and/or polyacrylate-based dispersions containing unsaturated polymerisable groups.

The coating systems according to the invention can also contain such polyester-, polyurethane-, polyether-, polyamide-, polyvinyl ester-, polyvinyl ether-, polysiloxane-, polycarbonate- and/or polyacrylate-based dispersions that contain functional groups, such as alkoxysilane groups, hydroxy groups and/or isocyanate groups optionally present in blocked form. Dual-cure systems, which can be cured by two different mechanisms, can thus be prepared.

Likewise for dual-cure systems, it is also possible to add to the coating system according to the invention so-called crosslinkers. There are suitable preferably non-blocked and/or blocked polyisocyanates, polyaziridines, polycarbodiimides and also melamine resins.

Particular preference is given to non-blocked and/or blocked, hydrophilised polyisocyanates for aqueous coating compositions. Preferably 20 wt. %, particularly preferably ≦10 wt. %, of solid crosslinker are added, based on the solids content of the coating composition.

The coating systems according to the invention can also contain polyester-, polyurethane-, polyether-, polyamide-, polysiloxane-, polyvinyl ether-, polybutadiene-, polyisoprene-, chlorine rubber-, polycarbonate-, polyvinyl ester-, polyvinyl chloride-, polyacrylate-, polyurethane-, polyacrylate-, polyester acrylate-, polyether acrylate-, alkyd-, polycarbonate-, polyepoxy-, epoxy(meth)acrylate-based dispersions that do not contain functional groups. The degree of crosslinking density can accordingly be reduced, physical drying can be influenced, for example accelerated, or elastification or adaptation of the adhesion can be carried out.

Coating compositions containing the coating systems according to the invention can also contain amino crosslinker resins, based on melamine or urea, and/or polyisocyanates having free or blocked polyisocyanate groups, based on polyisocyanates, optionally containing hydrophilising groups, of hexamethylene diisocyanate, isophorone diisocyanate and/or toluoylidene diisocyanate with urethane, uretdione, iminooxadiazinedione, isocyanurate, biuret and/or allophanate structures. Carbodiimides or polyaziridines are also possible as further crosslinkers.

Binders, auxiliary substances and additives known in coating technology, for example pigments, colourings or mattifying agents, can be added to or combined with the coating systems according to the invention. Such substances are flow and wetting additives, slip additives, pigments, including metallic effect pigments, fillers, nanoparticles, light-stabilising particles, anti-yellowing additives, thickeners, and additives for reducing the surface tension.

The coating systems according to the invention are suitable for the coating of foils, deformation of the coated foil taking place between physical drying and UV curing.

The coating systems according to the invention are particularly suitable for clear lacquer applications on wood and plastics substrates, where blocking resistance is important after physical drying and good resistance to chemicals is important after radiation curing.

The coating systems according to the invention are also particularly suitable for wood and plastics applications with a pigment content ≧10 wt. %, based on the total formulation. If, owing to high pigment contents, the radiation-curable groups in the coating system react incompletely during the radiation curing, blocking-resistant coatings are obtained.

The present invention also provides coating compositions containing the radiation-curable, aqueous dispersions based on polyurethane acrylate according to the invention, as well as crosslinkers based on amino resins, blocked polyisocyanates, non-blocked polyisocyanates, polyaziridines and/or polycarbodiimides, and/or one or more further dispersions.

This invention further provides substrates coated with the coating systems according to the invention.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

The NCO content was determined in each case by titrimetry in accordance with DIN 53185.

The solids content was determined by gravimetry in accordance with DIN 53216 after removal of all non-volatile constituents by evaporation.

The mean particle size was determined by laser correlation spectroscopy.

### Example 1

### Preparation of a Polyester According to the Invention, Component C

6574 parts of isophthalic acid, component C2, 1327 parts of trimethylolpropane, component C1, 7207 parts of neopentyl glycol, component C1, and 4 parts of Fascat® 4100 (butylstannonic acid, Arcema Inc., Philadelphia, Pa., US) were together heated to 190° C., with stirring. That temperature was maintained until an acid number of less than 1.5 mg KOH/g of substance was achieved. A polyester having a mean functionality of 2.3 and a hydroxyl number of 365 mg KOH/g of substance was obtained.

### Example 2

### Preparation of a Polyester According to the Invention, Component C

1661 parts of isophthalic acid, component C2, 1661 parts of terephthalic acid, component C2, 782 parts of ethylene glycol, component C1, 1206 parts of neopentyl glycol, component C1, and 1.5 parts of Fascat® 4100 (butylstannonic acid, Arcema Inc., Philadelphia, Pa., US) were together heated to 190° C., with stirring. That temperature was maintained until an acid number of less than 1.5 mg KOH/g of substance was achieved. A polyester having a mean functionality of 2.0 and a hydroxyl number of 99 mg KOH/g of substance was obtained.

### Example 3

### Preparation of a Polyester According to the Invention, Component C

1480 parts of phthalic anhydride, component C2, and 985 parts of ethylene glycol, component C1, were together heated to 220° C., with stirring. That temperature was maintained until an acid number of less than 1.5 mg KOH/g of substance was achieved. A polyester having a mean functionality of 2.0 and a hydroxyl number of 288 mg KOH/g of substance was obtained.

### Example 4

### Preparation of a Polyester not According to the Invention, Component C

1460 parts of adipic acid, component C2, 219 parts of trimethylolpropane, component C1, and 1435 parts of neopentyl glycol, component C1, were together heated to 220° C., with stirring. That temperature was maintained until an acid number of less than 1.5 mg KOH/g of substance was achieved. A polyester having a mean functionality of 2.3 and a hydroxyl number of 255 mg KOH/g of substance was obtained.

### Example 5

### Preparation of a UV-Curable, Aqueous Polyurethane Dispersion According to the Invention

29.6 parts of the polyester from Example 1), component C, were melted at 65° C. in 66 parts of acetone. 156 parts of the polyester acrylate Laromer® 8800 (BASF SE, Ludwigshafen, Del.) having an OH number of 70 mg KOH/g of substance, component A, 7.0 parts of neopentyl glycol, component D, 18.2 parts of dimethylolpropionic acid, component E, 34.7 parts of hexamethylene diisocyanate, component F, 69.5 parts of isophorone diisocyanate, component F, and 0.15 part of dibutyltin dilaurate were then added at 40° C., and the mixture was stirred and reacted at 60° C., with stirring, to an NCO content of 2.0 wt. %. Neutralisation was then carried out by adding and stirring in 10.8 parts of triethylamine. The clear solution was introduced into 605 parts of water, with stirring. A mixture of 6.1 parts of ethylenediamine, component G, and 33 parts of water was then added to the dispersion, with stirring. The acetone was subsequently removed from the dispersion by distillation under a slight vacuum. A UV-curable, aqueous polyurethane dispersion according to the invention 5) having a solids content of 35 wt. %, a mean particle size of 60 nm and a pH value of 8.3 was obtained.

### Example 6

### Preparation of a UV-Curable, Aqueous Polyurethane Dispersion According to the Invention

157 parts of the polyester acrylate Agisyn® 720 (AGI Co., Taipei, Taiwan) having an OH number of 116 mg KOH/g of substance, component A, 257 parts of an 80% solution of the polyester from Example 2) in acetone, component C, 15.6 parts of 1,4-butanediol, component D, 20.1 parts of dimethylolpropionic acid, component E, 50.4 parts of hexamethylene diisocyanate, component F, 102.2 parts of isophorone diisocyanate, component F, and 0.6 part of dibutyltin dilaurate were stirred into 126 parts of acetone at 40° C. and reacted at 60° C., with stirring, to an NCO content of 1.4 wt. %. Neutralisation was then carried out by adding and stirring in 12.1 parts of triethylamine. The clear solution was introduced into 850 parts of water, with stirring. A mixture of 8.1 parts of ethylenediamine, component G, and 24 parts of water was then added to the dispersion, with stirring. The acetone was subsequently removed from the dispersion by distillation under a slight vacuum. A UV-curable, aqueous polyurethane dispersion according to the invention 6) having a solids content of 42 wt. %, a mean particle size of 88 nm and a pH value of 8.1 was obtained.

### Example 7

### Preparation of a UV-Curable, Aqueous Polyurethane Dispersion According to the Invention

157 parts of the polyester acrylate Agisyn® 720 (AGI Co., Taipei, Taiwan) having an OH number of 116 mg KOH/g of substance, component A, 60.2 parts of the polyester from Example 3), component C, 15.6 parts of 1,4-butanediol, component D, 20.1 parts of dimethylolpropionic acid, component E, 50.4 parts of hexamethylene diisocyanate, component F, 102.2 parts of isophorone diisocyanate, component F, and 0.6 part of dibutyltin dilaurate were stirred into 126 parts of acetone at 40° C. and reacted at 60° C., with stirring, to an NCO content of 1.9 wt. %. Neutralisation was then carried out by adding and stirring in 12.1 parts of triethylamine. The clear solution was introduced into 590 parts of water, with stirring. A mixture of 6.9 parts of ethylenediamine, component G, and 24 parts of water was then added to the dispersion, with stirring. The acetone was subsequently removed from the dispersion by distillation under a slight vacuum. A UV-curable, aqueous polyurethane dispersion according to the invention 7) having a solids content of 41 wt. %, a mean particle size of 65 nm and a pH value of 8.1 was obtained.

### Example 8

### Preparation of a UV-Curable, Aqueous Polyurethane Dispersion According to the Invention

156 parts of the polyester acrylate Laromer® 8800 (BASF SE, Ludwigshafen, Del.) having an OH number of 70 mg KOH/g of substance, component A, 29.6 parts of the polyester from Example 1), component C, 7.0 parts of neopentyl glycol, component D, 18.2 parts of dimethylolpropionic acid, component E, 34.7 parts of hexamethylene diisocyanate, component F, 69.5 parts of isophorone diisocyanate, component F, and 0.15 part of dibutyltin dilaurate were stirred into 66 parts of acetone at 40° C. and reacted at 60° C., with stirring, to an NCO content of 2.0 wt. %. Neutralisation was then carried out by adding and stirring in 10.8 parts of triethylamine, and 111 parts of the ditrimethylolpropane tetraacrylate Ebecryl® 140 (Cytec Surface Specialties SA/NV, Drogenbos, Belgium), component ii, were added. The clear solution was introduced into 605 parts of water, with stirring. A mixture of 6.1 parts of ethylenediamine, component G, and 33 parts of water was then added to the dispersion, with stirring. The acetone was subsequently removed from the dispersion by distillation under a slight vacuum. A UV-curable, aqueous polyurethane dispersion according to the invention 8) having a solids content of 41 wt. %, a mean particle size of 81 nm and a pH value of 8.0 was obtained.

### Example 9

### Preparation of a UV-Curable, Aqueous Polyurethane Dispersion According to the Invention

1683 parts of the polyester acrylate Laromer® PE 44 F (BASF SE, Ludwigshafen, Del.) having an OH number of 80 mg KOH/g of substance, component A, 89.4 parts of pentaerythritol triacrylate, component B, 2611 parts of an 80% solution of the polyester from Example 2) in acetone, component C, 188 parts of dimethylolpropionic acid, component E, 957 parts of toluene 2,4-diisocyanate, component F, and 1.0 part of dibutyltin dilaurate were stirred into 1621 parts of acetone at 40° C. and reacted at 60° C., with stirring, to an NCO content of 1.3 wt. %. Neutralisation was then carried out by stirring in 142 parts of triethylamine and, after dilution with a further 1236 parts of acetone, 96.9 parts of piperazine were added. 6500 parts of water were added to the clear solution, with stirring. The acetone was subsequently removed from the dispersion by distillation under a slight vacuum. A UV-curable, aqueous polyurethane dispersion according to the invention 9) having a solids content of 41 wt. %, a mean particle size of 94 nm and a pH value of 8.3 was obtained.

### Example 10

### Preparation of a UV-Curable, Aqueous Polyurethane Dispersion According to the Invention

157 parts of the polyester acrylate Agisyn® 720 (AGI Co., Taipei, Taiwan) having an OH number of 116 mg KOH/g of substance, component A, 257 parts of an 80% solution of the polyester from Example 2) in acetone, component C, 15.6 parts of 1,4-butanediol, component D, 20.1 parts of dimethylolpropionic acid, component E, 50.4 parts of hexamethylene diisocyanate, component F, 102.2 parts of isophorone diisocyanate, component F, and 0.6 part of dibutyltin dilaurate were stirred into 126 parts of acetone at 40° C. and reacted at 60° C., with stirring, to an NCO content of 0.1 wt. %. Neutralisation was then carried out by adding and stirring in 12.1 parts of triethylamine. The clear solution was introduced into 850 parts of water, with stirring. The acetone was subsequently removed from the dispersion by distillation under a slight vacuum. A UV-curable, aqueous polyurethane dispersion according to the invention 10) having a solids content of 41 wt. %, a mean particle size of 90 nm and a pH value of 8.0 was obtained.

### Example 11

### Preparation of a UV-Curable, Aqueous Polyurethane Dispersion not According to the Invention

157 parts of the polyester acrylate Agisyn® 720 (AGI Co., Taipei, Taiwan) having an OH number of 116 mg KOH/g of substance, component A, 88.5 parts of the polyester from Example 4), component C, 15.6 parts of 1,4-butanediol, component D, 20.1 parts of dimethylolpropionic acid, component E, 50.4 parts of hexamethylene diisocyanate, component F, 102.2 parts of isophorone diisocyanate, component F, and 0.6 part of dibutyltin dilaurate were stirred into 126 parts of acetone at 40° C. and reacted at 60° C., with stirring, to an NCO content of 1.9 wt. %. Neutralisation was then carried out by adding and stirring in 12.1 parts of triethylamine. The clear solution was introduced into 630 parts of water, with stirring. A mixture of 7.2 parts of ethylenediamine, component G, and 24 parts of water was then added to the dispersion, with stirring. The acetone was subsequently removed from the dispersion by distillation under a slight vacuum. A UV-curable, aqueous polyurethane dispersion not according to the invention 11) having a solids content of 41 wt. %, a mean particle size of 86 nm and a pH value of 8.3 was obtained.

### Example 12

### Preparation of the Polyester Acrylate A1) According to Example 1 of EP-B 872 502

224.9 parts of 1,6-hexanediol, 96.6 parts of trimethylolpropane, 146.0 parts of adipic acid, 144.3 parts of acrylic acid, 3.1 parts of p-toluenesulfonic acid, 1.7 parts of hydroquinone monomethyl ether, 0.6 part of 2,6-di-tert-butylcresol and 250 parts of n-heptane were reacted for 10 hours at 96° C. with stirring, while boiling under reflux and while separating off water. The solvent was then removed by distillation. The OH number was 165 mg KOH/g, the acid number was 1.0 mg KOH/g and the dynamic viscosity was 520 mPas, measured in accordance with DIN 53018 at 23° C.

### Example 13

### Preparation of the Addition Product f1) According to Example 1 of EP-B 872 502

55.0 parts of 2-hydroxyethyl acrylate and 0.06 part of dibutyltin oxide were placed in a reaction vessel equipped with a stirrer, a thermometer, a dropping funnel, a reflux condenser and adjustable heating. The mixture was heated to 110° C., while passing through an intensive stream of air, and 45.94 parts of ε-caprolactone were metered in via the dropping funnel in the course of one hour. Heating at 110° C. was continued for a further 3 hours, with stirring, until a viscosity in the range of 66-70 sec at 23° C. was achieved (DIN EN ISO 2431).

### Example 14

### Preparation of an Aqueous, UV-Curable Polyurethane Dispersion According to Example 1 of EP-B 872 502

214.0 parts of 1-isocyanato-3,3,5-trimethyl-5-isocyanatomethylcyclohexane were added dropwise, with stirring, at temperatures of from 55 to 70° C., in the course of 3 hours, to a mixture of 200 parts of the polyester acrylate from Example 12), 68.4 parts of the addition product from Example 13), 36.0 parts of dimethylolpropionic acid and 23.9 parts of triethylamine. During the after-reaction at a temperature of 75 to 80° C., the NCO content fell to a constant value of 2.2 wt. %. The resulting prepolymer was then dispersed, with vigorous stirring, in 749.4 parts of water at a temperature of 38 to 42° C. A mixture of 9.6 parts of ethylenediamine and 14.3 parts of water was then added dropwise to the resulting dispersion in the course of 15 minutes, at the same temperature. Stirring was then continued until no further isocyanate could be detected at 2270 cm^{-l} by IR spectroscopy. A UV-curable, aqueous polyurethane dispersion 14) according to Example 1 of EP-B 872 502 having a solids content of 40 wt. %, a mean particle size of 99 nm and a pH value of 7.6 was obtained.

### Example 15

### Preparation of an Aqueous, UV-Curable Polyurethane Dispersion According to Example 5 of EP-B 942 022

41.3 parts of the adipic-acid-based polyester acrylate AgiSyn® 720 (AGI Co., Taipei, Taiwan), 90.1 parts of the polyepoxy acrylate AgiSyn® 1010 (AGI Co., Taipei, Taiwan), 17.1 parts of dimethylolpropionic acid, 33.6 parts of hexamethylene diisocyanate, 44.4 parts of 1-isocyanato-3,3,5-trimethyl-5-isocyanatomethylcyclohexane and 0.24 part of dibutyltin dilaurate were dissolved in 131 parts of acetone and reacted at 60° C., with stirring, to an NCO content of 1.60 wt. %. Neutralisation was then carried out by adding and stirring in 12.7 parts of triethylamine. The clear solution was introduced into 500 parts of water, with stirring. A mixture of 3.6 parts of ethylenediamine and 30 parts of water was then added to the dispersion, with stirring. The acetone was subsequently removed from the dispersion by distillation under a slight vacuum. A UV-curable, aqueous polyurethane dispersion 15) according to Example 5 of EP-B 942 022 having a solids content of 32.8 wt. %, a mean particle size of 90 nm and a pH value of 8.4 was obtained.

### Example 16

### Preparation of an Aqueous, UV-Curable Polyurethane Dispersion According to Example 2 of EP-B 753 531

150.2 parts of the polyester acrylate Laromer® 8800 (BASF AG, Ludwigshafen, Del.), 15.0 parts of dimethylolpropionic acid, 24.0 parts of hexamethylene diisocyanate, 31.7 parts of 1-isocyanato-3,3,5-trimethyl-5-isocyanatomethylcyclohexane and 0.22 part of dibutyltin dilaurate were dissolved in 129 parts of acetone and reacted at 60° C., with stirring, to an NCO content of 2.20 wt. %. Neutralisation was then carried out by adding and stirring in 11.2 parts of triethylamine. The clear solution was introduced into 515 parts of water, with stirring. A mixture of 3.6 parts of ethylenediamine and 30.0 parts of water was then added to the dispersion, with stirring. The acetone was subsequently removed from the dispersion by distillation under a slight vacuum. A UV-curable, aqueous polyurethane dispersion 16) according to Example 2 of EP-B 753 531 having a solids content of 29.0 wt. %, a mean particle size of 180 nm and a pH value of 7.7 was obtained.

TABLE 1
Formulations for pigmented systems

| | Pigmented | |
|---|---|---|
| | lacquers | |
| | [A-1] and [A-2] | Clear lacquer [A-3] |
| | (parts by weight) | (parts by weight) |
| UV dispersion (adapted to 40% | 122.00 | 150 |
| solids) | | |
| Butyl glycol/water (1:1) | 10.00 | 12 |
| Silicone surface-active additive | 0.20 | — |
| BYK ® 373¹ | | |
| Wetting agent BYK ® 346² | 0.40 | 0.3 |
| Irgacure ® 500³ | 2.00 | 1.5 |
| Irgacure ® 819 DW⁴ | 2.00 | — |
| Antifoam Dehydran 1293⁵ | 1.00 | |
| TiO₂ paste Apuis 0062⁶ | 49.00 | — |
| Thickener BYK ® 425⁷ | 2.00 | 0.4 |
| Water | 11.40 | — |
| Total | 200.00 | 164.2 |

TABLE 2
Application and curing conditions for pigmented systems

| | Pigmented | Pigmented | Clear lacquer |
|---|---|---|---|
| | lacquers [A-1] | lacquers [A-2] | [A-3] |
| Substrate | Wood | Glass | Glass |
| Knife | Case knife, 2 × | Case knife, 1 × | Case knife, 1 × |
| application | 150 μm, wet film | 150 μm, wet film | 150 μm, wet film |
| Aeration time | 10 min, 50° C. | 10 min, 50° C. | 10 min, 50° C. |
| Curing | 3 m/min | 3, 5 m/min⁹ | 3, 5 m/min⁹ |
| | (Ga + Hg)⁸ | (Ga + Hg)⁸ | (Hg)⁸ |

¹solution of a polyether-modified, hydroxy-functional polydimethylsiloxane from BYK, Wesel, DE
²solution of a polyether-modified polydimethylsiloxane from BYK, Wesel, DE
³a mixture of benzophenone and (1-hydroxycyclohexyl)phenyl ketone from Ciba, Lampertheim, DE
⁴phenylbis-(2,4,6-trimethylbenzoyl)-phosphine oxide from Ciba, Lampertheim, DE
⁵modified polydimethylsiloxane from Cognis, Düsseldorf, DE
⁶pigment paste from Heubach, Langelsheim, DE
⁷solution of a urea-modified polyurethane from BYK, Wesel, DE
⁸UV installation from Barberan, Model HOK - 6/2 (about 80 W/cm)
⁹In order to test the reactivity, the hardness in pendulum seconds (according to DIN 53157) achieved after full curing, as a function of various belt speeds, is measured. If the pendulum hardness remains above 100 pendulum seconds even at the highest belt speed, then the coating has excellent reactivity.

After UV curing, the coated substrates are stored (wood for 1 day at 50° C., glass for 1 hour at room temperature in an desiccator) and then subjected to the tests.

TABLE 3
Data relating to the application-technological testing of pigmented
systems

| | | Exam- | Exam- | |
|---|---|---|---|---|
| | | ple 14 | ple 15 | Example |
| | | (EP-B | (EP-B | 16 |
| Application-technological | Example | 872 | 942 | (EP-B |
| testing | 5 | 502) | 022) | 753 531) |
| Film transparency¹⁰, clear | 4 | 5 | 2 | 4 |
| lacquer [A-3] | | | | |
| Storage stability: 50° C./24 h | OK | OK | OK | OK |
| Storage stability: 40° C./28 d | OK | OK | OK | OK |
| Water resistance¹¹, pigmented | 5 | 5 | 5 | 5 |
| lacquer [A-1] | | | | |
| Resistance to coffee¹¹, | 4 | 2-3 | 2-3 | 2-3 |
| pigmented lacquer [A-1] | | | | |
| Resistance to ethanol/water | 4 | 3-4 | 4 | 2 |
| (50%)¹¹, pigmented lacquer | | | | |
| [A-1] | | | | |
| Resistance to red wine¹¹, | 4 | 3 | 3 | 3 |
| pigmented lacquer [A-1] | | | | |
| Resistance to ethanol (98%)¹¹, | 4 | 3 | 3 | 2 |
| pigmented lacquer [A-1] | | | | |
| König pendulum hardness, | 30 sec | 14 sec | 14 sec | 10 sec |
| clear lacquer [A-3] after | | | | |
| physical drying | | | | |
| König pendulum hardness, | 161 sec, | 94 sec, | 182 sec, | 130 sec, |
| clear lacquer [A-3] after UV | 160 sec | 77 sec | 178 sec | 116 sec |
| curing | | | | |
| König pendulum hardness, | 139 sec, | 55 sec, | 119 sec, | 108 sec, |
| pigmented lacquer [A-2] | 125 sec | 46 sec | 104 sec | 87 sec |
| Whitening after scratching¹², | 5 | 5 | 4 | 5 |
| clear lacquer [A-3] | | | | |

¹⁰The film transparency is assessed visually by application of a film to a sheet of glass and subsequent physical drying: Rating 5: clear, no discernible cloudiness or haze formation Rating 4: slight haze formation is discernible at an observation angle of about 10-20° Rating 3: slight cloudiness is discernible at an observation angle of about 45-80° Rating 2: pronounced cloudiness Rating 1: matt surface or gritty surface
¹¹The resistance properties are assessed by visual inspection after 16 hours' loading: Rating 5: no visible changes (no damage) Rating 4: slight change in gloss or shade of colour, only visible when the light source is reflected in the test surface at or close to the marking and is reflected directly into the eye of the observer, or some limited markings which are just discernible (swelling ring discernible, or no discernible softening with the fingernail) Rating 3:slight marking visible from several viewing angles, for example an almost complete circle or circular area which is just discernible (swelling ring discernible, scratches with the fingernail discernible) Rating 2: considerable marking, but the surface structure is largely unchanged (closed swelling ring, visible scratches) Rating 1: considerable marking, but the surface structure is largely unchanged, marking can be scratched through to the substrate Rating 0: considerablemarking, the surface structure is changed or the surface material is wholly or partly destroyed or the filter paper adheres to the surface.
¹²The whitening after scratching is tested by scratching with a coin. If no whitening is discernible at the scratch site, this result is rated as excellent (rating 5).

TABLE 4
Formulations for clear lacquer systems

| | Clear lacquer [A-4, A- |
|---|---|
| | 5] (parts by weight) |
| UV dispersion (adapted to 40% | 150 |
| solids) | |
| Butyl glycol/water (1:1) | 12 |
| Irgacure ® 500³ | 1.5 |
| Wetting agent BYK ® 346² | 0.3 |
| Thickener BYK ® 425⁷ | 0.4 |
| Total | 164.2 |

TABLE 5
Application and curing conditions for clear lacquer systems

| | Clear lacquer [A-4] | Clear lacquer [A-5] |
|---|---|---|
| Substrate | Wood | Glass |
| Knife application | Case knife, 1 × 150 μm, | Case knife, 1 × 150 μm, |
| | wet film | wet film |
| Aeration time | 10 min, 50° C. | 10 min, 50° C. |
| Curing | 3, 5 m/min⁹ (Hg)⁸ | 3, 5 m/min⁹ (Hg)⁸ |

After UV curing, the coated substrates are stored (glass for 1 hour at room temperature in a desiccator) and then subjected to the tests.

TABLE 6
Data relating to the application-technological testing of clear lacquer systems

| | | | | | | | Example | | |
|---|---|---|---|---|---|---|---|---|---|
| | | | | | | | 14 | Example 15 | Example 16 |
| | | | | | | Example | (EP-B 872 | (EP-B 942 | (EP-B 753 |
| Application-technological test | Example 5 | Example 6 | Example 7 | Example 8 | Example 9 | 11 | 502) | 022) | 531) |
| Film transparency¹⁰, clear lacquer | 5 | 5 | 5 | 5 | 5 | 5 | 5 | 5 | 2 |
| [A-5] | | | | | | | | | |
| Storage stability: 50° C./24 h | OK | OK | OK | OK | OK | OK | OK | OK | OK |
| Storage stability: 40° C./28 d | OK | OK | OK | OK | OK | OK | OK | OK | OK |
| Water resistance¹¹, clear lacquer | 5 | 5 | 5 | 5 | 5 | 5 | 5 | 5 | 5 |
| [A-4] | | | | | | | | | |
| Resistance to coffee¹¹, clear lacquer | 5 | 5 | 5 | 5 | 5 | 5 | 5 | 5 | 5 |
| [A-4] | | | | | | | | | |
| Resistance to ethanol/water | 5 | 5 | 5 | 5 | 5 | 4 | 4 | 4 | 5 |
| (50%),¹¹ clear lacquer [A-4] | | | | | | | | | |
| Resistance to red wine¹¹, clear | 5 | 5 | 4-5 | 5 | 5 | 5 | 5 | 5 | 5 |
| lacquer [A-4] | | | | | | | | | |
| Resistance to ethanol (98%)¹¹, clear | 4-5 | 4 | 4 | 5 | 5 | 3 | 3 | 3 | 3 |
| lacquer [A-4] | | | | | | | | | |
| Konig pendulum hardness, clear | 29 sec | 20 sec | 13 sec | 19 sec | 41 sec | tacky | 14 sec | 14 sec | 10 sec |
| lacquer [A-5] after physical drying | | | | | | | | | |
| Konig pendulum hardness, clear | 164 sec, | 144 sec, | 152 sec, | 181 sec, | 143 sec, | 129 sec, | 94 sec, | 182 sec, | 130 sec, |
| lacquer [A-5] after UV curing | 158 sec | 102 sec | 112 sec | 169 sec | 125 sec | 88 sec | 77 sec | 178 sec | 116 sec |
| Whitening after scratching,¹² clear | 5 | 5 | 5 | 5 | 5 | 5 | 5 | 4 | 5 |
| lacquer [A-5] | | | | | | | | | |

In the pigmented formulation, Example 5) according to the invention exhibits markedly better stain resistance to coffee and red wine and better resistance to ethanol as compared with Comparison Examples 14), 15) and 16). In addition, very marked initial physical drying and high pendulum hardnesses after radiation curing are achieved for Example 5).

In the clear lacquer formulation, Examples 5) to 9) are superior to Comparison Examples 14) to 16) in terms of resistance to ethanol. Higher pendulum hardnesses tend to be achieved both after physical drying and after radiation curing, without poorer values being obtained in respect of whitening after scratching. In Comparison Example 15), the slightly poorer value for whitening after scratching shows that the high pendulum hardness after radiation curing, which is caused in particular by the high content of polyepoxy acrylate, leads to a certain embrittlement of the film Example 11, not according to the invention, clearly shows the softening effect of the adipic-acid-containing polyester after physical drying and after radiation curing.

1. A radiation-curable, aqueous dispersion based on polyurethane acrylates (i) comprising as structural components
A) an oligomeric or polymeric compound comprising an isocyanate-reactive group and a radically copolymerisable group;
B) optionally a monomeric compound other than A comprising a hydroxy functional group and a (meth)acrylate group;
C) a polyester polyol obtained from
C1) an aliphatic diol comprising from 2 to 4 carbon atoms between the two OH functional groups of said aliphatic diol and/or an aliphatic triol, and
C2) an aromatic di- and/or tri-carboxylic acid;
D) optionally a polyol other than A, B, and C;
E) a compound comprising an isocyanate-reactive group towards and a non-ionic group, an ionic group, or a group capable of forming an ionic group, wherein said compound has a dispersing action;
F) an organic polyisocyanate;
G) optionally a compound other than A, B, C, D, and E comprising an isocyanate-reactive group.

2. The radiation-curable, aqueous dispersion of claim 1, further comprising a reactive diluent (ii) comprising a radically polymerisable group.

3. The radiation-curable, aqueous dispersion of claim 1, wherein structural component C is used in an amount of from 5 to 75 weight %, wherein the sum of the amounts of components A, B, C, D, E, F, and G equals 100 weight %.

4. The radiation-curable, aqueous dispersion of claim 1, wherein structural component C has an OH number in the range of from 20 to 500 mg KOH/g of substance.

5. The radiation-curable, aqueous dispersion of claim 1, wherein structural component A is selected from the group consisting of polyester(meth)acrylates comprising hydroxyl groups, polyether(meth)acrylates comprising hydroxyl groups, polyether ester(meth)acrylates comprising hydroxyl groups, and polyepoxy(meth)acrylates comprising hydroxyl groups.

6. The radiation-curable, aqueous dispersion of claim 1, wherein component C1 is selected from the group consisting of 1,2-ethanediol, 1,2-propanediol, 1,3-propanediol, neopentyl glycol, 2-ethyl-2-butylpropanediol, 1,3-butanediol, 1,2-cyclohexanediol, 1,4-cyclohexanediol, 1,4-butanediol, trimethylolethane, trimethylolpropane, trimethylolbutane, glycerol, castor oil, and mixtures thereof and component C2 is selected from the group consisting of phthalic acid, phthalic anhydride, isophthalic acid, isophthalic anhydride, terephthalic acid, terephthalic anhydride, trimellitic acid, trimellitic anhydride, and mixtures thereof.

7. The radiation-curable, aqueous dispersion of claim 1, wherein component C1 is selected from the group consisting of 1,2-ethanediol, 1,2-propanediol, neopentyl glycol, trimethylolpropane, and mixtures thereof, and component C2 is selected from the group consisting of isophthalic acid, terephthalic acid, and mixtures thereof.

8. The radiation-curable, aqueous dispersion of claim 1, wherein structural component E is selected from the group consisting of 2-(2-amino-ethylamino)ethanesulfonic acid, 3-(cyclohexylamino)propane-1-sulfonic acid, the addition product of isophoronediamine and acrylic acid, hydroxypivalic acid, dimethylolpropionic acid, triethanolamine, tripropanolamine, N-methyldiethanolamine, N,N-dimethylethanolamine, monofunctional mixed polyalkylene oxide polyethers containing at least 40 mol % ethylene oxide units and no more than 60 mol % propylene oxide units, and mixtures thereof.

9. The radiation-curable, aqueous dispersion of claim 1, wherein structural component F is selected from the group consisting of the polyisocyanates 1,6-hexamethylene diisocyanate, 1-isocyanato-3,3,5-trimethyl-5-isocyanatomethylcyclohexane, 4,4′-diisocyanato-dicyclohexylmethane, and mixtures thereof; homologues of 1-isocyanato-3,3,5-trimethyl-5-isocyanatomethylcyclohexane with biuret, carbodiimide, isocyanurate, allophanate, iminooxadiazinedione, and/or uretdione groups, oligomers of 1-isocyanato-3,3,5-trimethyl-5-isocyanatomethylcyclohexane with biuret, carbodiimide, isocyanurate, allophanate, iminooxadiazinedione, and/or uretdione groups, homologues of 4,4′-diisocyanato-dicyclohexylmethane with biuret, carbodiimide, isocyanurate, allophanate, iminooxadiazinedione, and/or uretdione groups, oligomers of 4,4′-diisocyanato-dicyclohexylmethane with biuret, carbodiimide, isocyanurate, allophanate, iminooxadiazinedione, and/or uretdione groups, and mixtures thereof; and mixtures of said homologues and/or said oligomers with said polyisocyanates.

10. A process for preparing the radiation-curable, aqueous dispersion of claim 1, comprising
reacting components A, B, C, D, and E in one or more reaction steps with component F to obtain a polyurethane acrylate prepolymer (i), wherein a neutralising agent for producing ionic groups is optionally added before, during, or after the preparation of said polyurethane acrylate prepolymer;
adding water to said polyurethane acrylate prepolymer or converting said polyurethane acrylate prepolymer into an aqueous initial charge to obtain a dispersion; and
optionally chain extending said polyurethane acrylate prepolymer with component G before, during or after obtaining said dispersion.

11. The process of claim 10, wherein the molar ratios of isocyanate groups in F to isocyanate-reactive groups in A, B, C, D and E is from 0.8:1 to 2.5:1.

12. The process of claim 10, wherein one more reactive diluents having at least one radically polymerisable group (component ii) is/are added as a further component.

13. A coating, lacquer, or adhesive comprising the radiation-curable, aqueous dispersion of claim 1.

14. A coating composition comprising the radiation-curable, aqueous dispersion of claim 1, a crosslinker based on an amino resin, a blocked polyisocyanate, a non-blocked polyisocyanate, a polyaziridine and/or a polycarbodiimide, and/or a further dispersion.

15. A substrate coated with coating composition of claim 14.
